(19) United States
(12) Patent Application Publication
(10) Pub. No.: US 2007/0295718 A1
(43) Pub. Date: Dec. 27, 2007

(54) MICROWAVE OVEN

(75) Inventors: Tamotsu Takei, Nagoya (JP); Tomimitsu Noda, Gifu (JP); Kazuhiro Furuta, Seto (JP)

Correspondence Address: DLA PIPER US LLP, P. O. BOX 9271, RESTON, VA, 20195, US

(73) Assignees: KABUSHIKI KAISHA TOSHIBA, Minato-Ku (JP); TOSHIBA HA PRODUCTS CO., LTD., Ibaraki (JP); TOSHIBA CONSUMER MARKETING CORPORATION, Chiyoda-Ku (JP)

(21) Appl. No.: 11/764,821

(22) Filed: Jun. 19, 2007

(30) Foreign Application Priority Data
Jun. 23, 2006 (JP) 2006-173645

(51) Int. Cl. H05B 6/64

(52) U.S. Cl. 219/756

(57) ABSTRACT

A microwave oven includes a heating chamber into which an object to be heated is placed and heated for a predetermined period of time, a microwave heating unit, a plurality of electrothermal heating units, and a secondary battery charged by a commercial AC power supply and supplying electric power to at least a specific one of the electrothermal heating units. The predetermined heating period of time includes a part in which the specific electrothermal heating unit to which electric power is supplied by the secondary battery is operated simultaneously with the other heating units.

### CROSS-REFERENCE TO RELATED APPLICATIONS

This application is based upon and claims the benefit of priority from the prior Japanese Patent Application No. 2006-173645 filed on Jun. 23, 2006, the entire contents of which are incorporated herein by reference.

### BACKGROUND OF THE INVENTION

1. Field of the Invention

The present invention relates to a microwave oven provided with a microwave heating unit and an electric heating unit.

2. Description of the Related Art

Microwave ovens such as microwave oven/range have conventionally been provided with a plurality of heating units such a magnetron and a heater so that water content in the surface of food is evaporated by a heater while an interior of food is heated by a magnetron, so that the texture of crispness is obtained. In this case, the voltage of the commercial AC supply is at 100 V, outputs of a plurality of heating units are controlled so that consumption current is at or below 15 A which value is a standard household wall plug in Japan, that is, electric power consumption is at or below 1500 W or so that a heating time of each heating unit is divided up. As a result, a cooking time is increased unnecessarily.

Furthermore, when compared with a microwave oven with a gas oven function using gas, the microwave oven with an electric heating function as described above has a problem that temperature rise in a heating chamber is slower due to inferiority in the heating power, whereupon the surface of food is dried with the result of worse finishing. In particular, the aforesaid tendency is remarkable when the power supply voltage is at 100 V.

To overcome the above-described problem, JP-2002-345640A discloses a cooker comprising a first heating unit carrying out a heating operation using a commercial power supply and a second heating unit carrying out heating using a battery cell. The cooker is arranged so that the second heating unit is operated according to a cooking condition. Furthermore, JP-H06-20773A discloses a microwave oven in which electric power from an external power supply is supplied to one a power converter and a heater and electric power of a storage battery is supplied to the other.

However, the technique disclosed by JP-2002-345640A is directed to electric rice cookers. When applied to a microwave oven, the disclosed technique does not correspond to heating modes of the microwave oven. Accordingly, the above-described problem cannot be overcome by the disclosed technique. Furthermore, JP-H06-20773A discloses a technique for simultaneously carrying out high-frequency heating and electric heating by the storage battery in the microwave oven. However, JP-H06-20773A discloses nothing about a specific control manner in the simultaneous execution of high-frequency heating and electric heating. Additionally, for example, since a storage battery has a definite limit in a capacity thereof, it is difficult to continuously carrying out the high-frequency heating and the electric heating.

### SUMMARY OF THE INVENTION

Therefore, an object of the present invention is to provide a microwave oven which comprises a microwave heating unit and a an electric heating unit and can reduce a cooking time by an effective use of a secondary battery.

The present invention provides a microwave oven comprising a heating chamber into which an object to be heated is placed and heated for a predetermined period of time, a microwave heating unit, a plurality of electrothermal heating units, and a secondary battery charged by a commercial AC power supply and supplying electric power to at least a specific one of the electrothermal heating units, wherein the predetermined heating period of time includes a part in which the specific electrothermal heating unit to which electric power is supplied by the secondary battery is operated simultaneously with the other heating units.

In the above-described arrangement, a heating output can be increased at a suitable period such that the cooking time can be reduced. Accordingly, the secondary battery can efficiently be used for reduction in the cooking time, and good cooking finish can be obtained.

### BRIEF DESCRIPTION OF THE DRAWINGS

Other objects, features and advantages of the present invention will become clear upon reviewing the following description of the embodiment with reference to the accompanying drawings, in which:

FIG. 1 is a block diagram schematically showing an electric arrangement of the control system of a microwave oven of a first embodiment in accordance with the present invention;

FIG. 2 is a longitudinally sectional side view of the microwave oven;

FIG. 3 is a front view of the microwave oven with a door being open;

FIG. 4 is a front view of the microwave oven with a door being closed;

FIG. 5 is a graph showing a charging characteristic of a secondary battery;

FIG. 6 is a graph showing a discharge rate of the secondary battery;

FIG. 7A shows a display displaying a charging state of the secondary battery;

FIG. 7B shows changes in the display in the case where the remaining capacity of the secondary battery is reduced;

FIG. 8A is a timing chart showing changes in an interior temperature in the case where a heating chamber is preheated and thereafter cooking is carried out by heaters;

FIG. 8B is a similar timing chart showing temperature changes in a conventional microwave oven;

FIGS. 9A and 9B are views similar to FIGS. 8A and 8B, showing a second embodiment in accordance with the invention, respectively;

FIG. 10 is a view similar to FIG. 9A, showing a third embodiment in accordance with the invention;

FIGS. 11A and 11B are views similar to FIGS. 9A and 9B, showing a case where both microwaves and heater are used in a fourth embodiment in accordance with the invention, respectively; and

FIG. 12 is a view similar to FIG. 8A, showing a fifth embodiment in accordance with the invention.

### DETAILED DESCRIPTION OF THE INVENTION

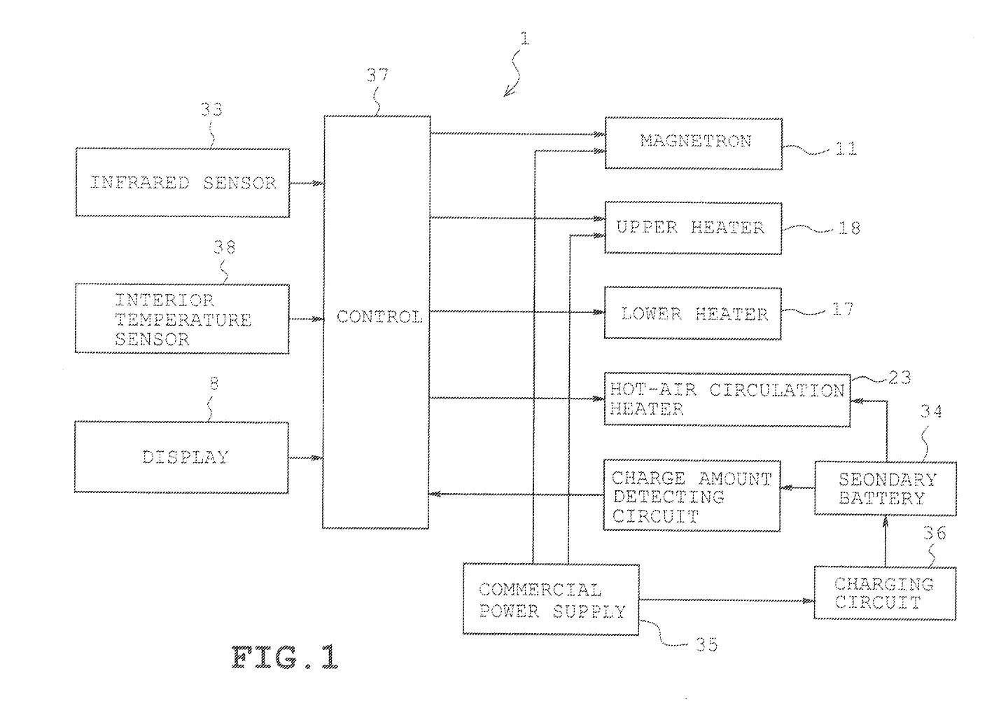

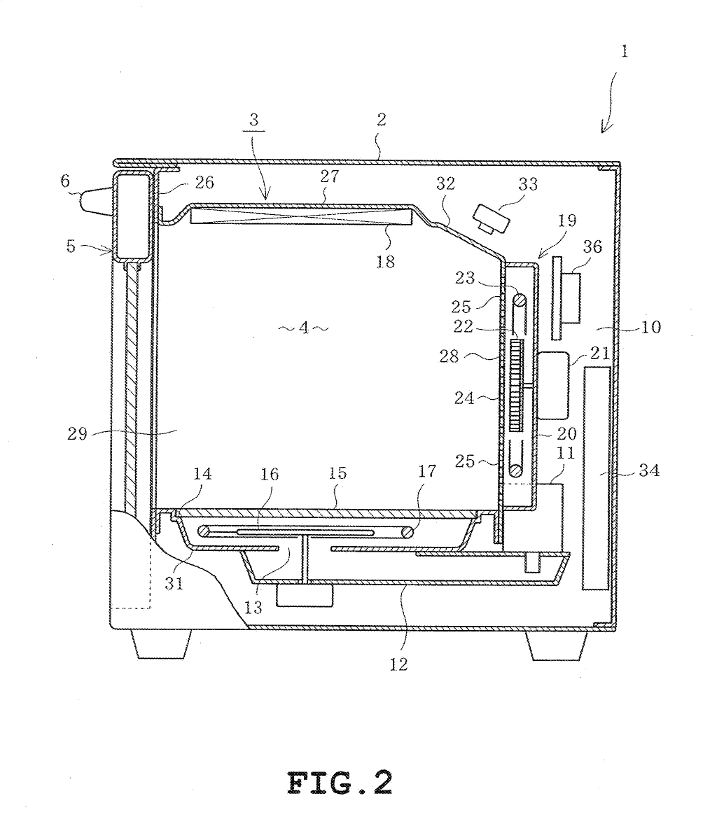

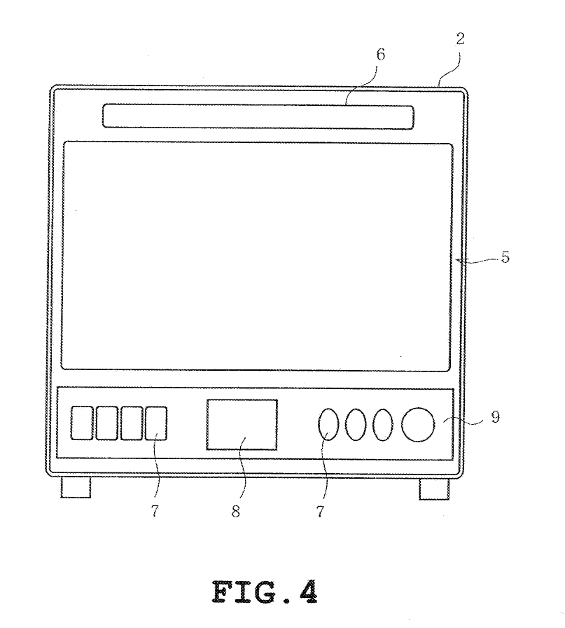

A first embodiment of the present invention will be described with reference to FIGS. 1 to 8B. Referring to FIGS. 2 to 4, a microwave oven 1 of the first embodiment is shown. The microwave oven 1 has an oven cooking function and comprises a body including a rectangular outer casing 2 having an open front and a rectangular inner casing (housing) 3 fixed in the outer casing 2 and also having an open front. The inner casing 3 has an interior defined as a heating chamber 4. The heating chamber 4 has a front opening closed and opened by a door 5 which is mounted on the body so as to be caused to vertically pivot.

The door 5 has a front including a hand grip 6 formed on an upper part of the front and an operation panel 9 provided on a lower part of the front. The operation panel 9 has a plurality of operating parts 7 and a display 8 (display unit). The operating parts 7 are used to set a cooking mode of heating, cooking time, interior temperature (set temperature) which is a temperature in the heating chamber 4 in which food is to be cooked, and the like. The display 8 is used to display a selected cooking mode, cooking time and the like. The operating panel 9 disposed on the lower part of the door 5 can reduce a crosswise space between the outer and inner casing 2 and 3, differing from the construction in which the operation panel 9 is mounted on the right of the door 5. As a result, a crosswise dimension of the outer casing 2 can be reduced.

The body of the microwave oven 1 includes a component chamber 10 which is formed in the rear interior thereof so as to be located between the outer and inner casings 2 and 3. The component chamber 10 encloses a magnetron (microwave heating unit) 11, a power supply unit for the magnetron 11, a cooling fan unit cooling the magnetron 11 and the power supply unit, and the like. The magnetron 11 generates high-frequency waves, which waves are supplied through a waveguide provided on the underside of the inner casing 3 and an excitation port 13 formed through the bottom of the inner casing 3 into the heating chamber 4.

The inner casing 3 has a stepped portion 14 formed inside the bottom thereof. A bottom plate 15 comprising a glass plate or a ceramic plate is placed on the stepped portion 14. The bottom plate 15 substantially constitutes the bottom of the heating chamber 4. A rotational antenna 16 is provided in a space defined below the bottom plate 15 for reflecting an agitating high-frequency waves supplied through the excitation port 13. A lower heater (electrothermal heating unit) 17 comprising a sheathed heater is provide in the space defined below the bottom plate 15 so as to surround the rotational antenna 16. An upper heater (electrothermal heating unit) 18 comprising a flat heater is provided in an upper interior of the inner chamber 3. Both heaters 17 and 18 serve as oven heaters.

On the other hand, a hot air generator 19 comprises a casing 20 fixed on the rear of the inner casing 3. The casing 20 encloses a centrifugal fan 22 driven by a fan motor 21 and hot-air circulation heater (specific electrothermal heating unit) 23. An air inlet 24 comprising a number of small holes is formed through the rear of the heating chamber 4 or a rear wall of the inner casing 3 so at to correspond to a central side of the fan 22. An air outlet 25 comprising a number of small holes is also formed through the rear wall of the inner casing 3 so as to be located at opposite sides of the air inlet 24.

Upon rotation of the fan 22 in the hot-air generator 19, air in the heating chamber 4 is drawn through the air inlet 24 and heated by the hot-air circulation heater 23, thereby being discharged through the air outlet 25 into the heating chamber 4. As a result, the atmosphere in the heating chamber 4 is heated by the hot-air circulation heater 23 by circulation of hot air as described above so that an oven cooking is carried out. Although two oven cooking pans (not shown) are disposed up and down in the heating chamber 4 in the oven cooking, the same amount of hot air is supplied through the upper and lower holes of the air outlet 25 as described above. Consequently, food placed on the upper and lower oven cooking pans can be cooked desirably.

The inner casing 3 is made of a metal plate such as a steel plate and comprises a rectangular flange plate 26 of the front, ceiling plate 27, rear plate 28, left side plate, right side plate and bottom plate 31. The ceiling plate 27 and rear plate 28 are formed by bending a single plate substantially into an L-shape. These plates 26 to 31 are bonded to one another. The front flange plate 26 is welded to the outer casing 2. A boundary between the ceiling and rear plates 27 and 28 or an upper rear ridge is formed into an inclined face 32 which is inclined rearwardly downward. The inclined face 32 has window (not shown) formed in the crosswise center thereof for detection of infrared radiation. An infrared sensor (temperature detecting unit) 33 is disposed so as to confront the window.

A secondary battery 34 comprising a lithium-ion battery and a charging circuit 36 are provided in the component chamber 10 as shown in FIG. 2. The charging circuit 36 charges the secondary battery 34 with electric power from a 100 V commercial AC power supply 35 (see FIG. 1). A lithium-ion battery is free of a memory effect as can be seen in nickel-cadmium batteries. Accordingly, the lithium-ion battery can be charged into a full charge state even when charging is initiated during discharge from the lithium-ion battery. Furthermore, the properties of the lithium-ion battery can be prevented from deterioration.

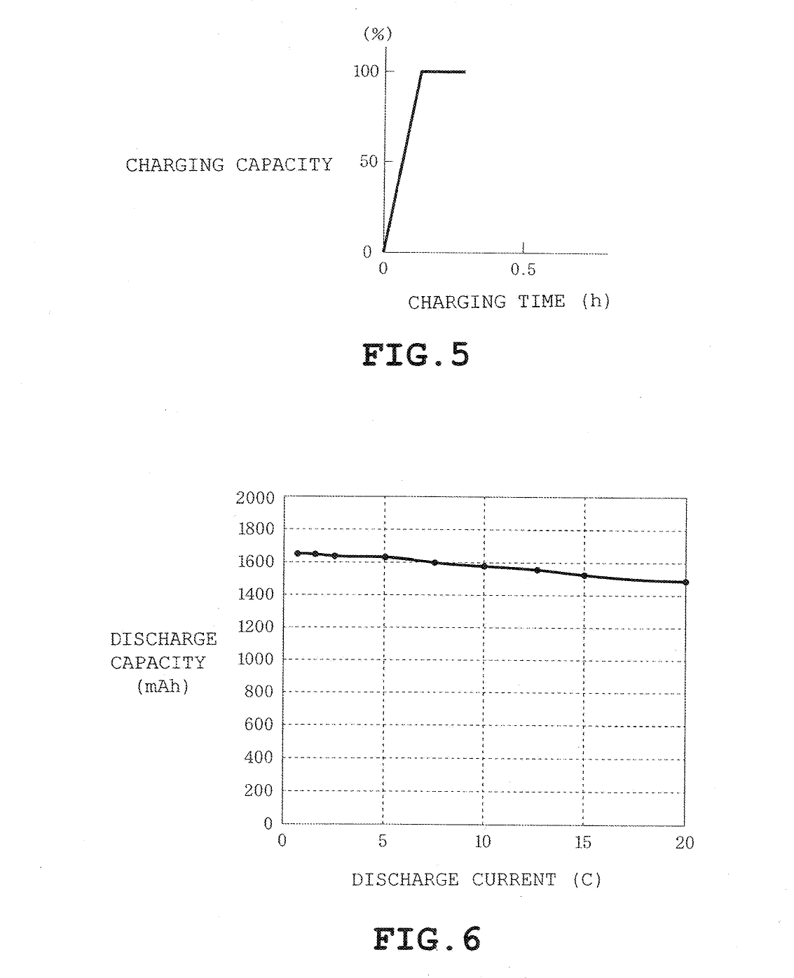

The secondary battery 34 has a terminal voltage set to, for example, about 33 V and can be full charged in about 12 minutes as shown in FIG. 5. Furthermore, the secondary battery 34 is designed so that the discharge capacity thereof is not reduced to a large degree even when current is discharged out of the secondary battery 34 at or above 5 C (discharge rate). For example, see JP-2004-296255A. Electric power of 1056 W (32 A×33 V) can be supplied for 3 minutes when discharge capacity of 1600 mAh is discharged at 20 C.

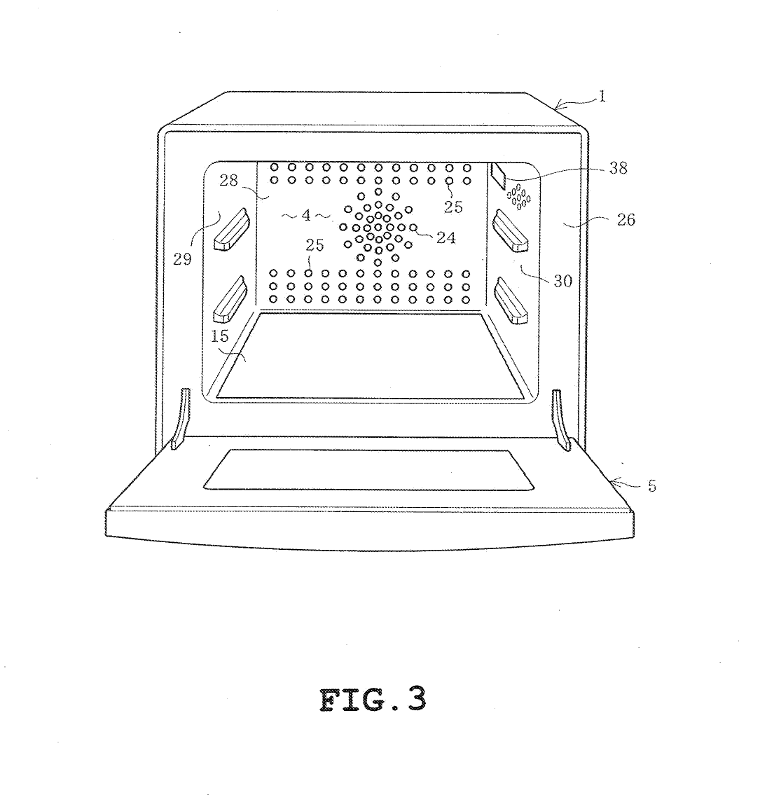

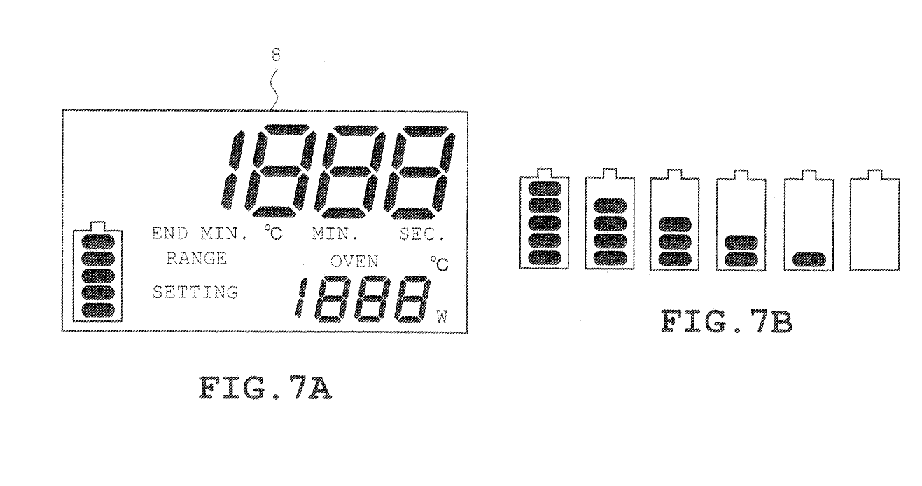

Referring to FIG. 1, an electrical arrangement of control system of the microwave oven 1 is schematically shown. The control system includes a control section 37 mainly composed of a microcomputer. Sensor signals are supplied from an infrared sensor 33, interior temperature sensor (temperature detecting unit) 38 (see FIG. 3) into the control section 37. The control section 37 controls the display 8, magnetron 11, heaters 17, 18 and 23 and the like. A charge amount detecting circuit 39 detects, for example, a terminal voltage of the secondary battery 34, thereby detecting a state of charge of the secondary battery 34 carried out via the charging circuit 36. The charge amount detecting circuit 39 delivers the results of detection to the control section 37. The control section 37 then controls the display 8 so that the detected charging state of the secondary battery 34 is displayed as shown in FIG. 7A, for example. Furthermore, FIG. 7B shows changes in the display in the case where the remaining capacity of the secondary battery 34 is gradually reduced. The magnetron 11 and upper and lower heaters 17 and 18 are powered from a commercial power supply 35, whereas the hot-air circulation heater 23 is powered from the secondary battery 34. The secondary battery 34 is charged while none of the heaters 17, 18 and 23 are basically driven.

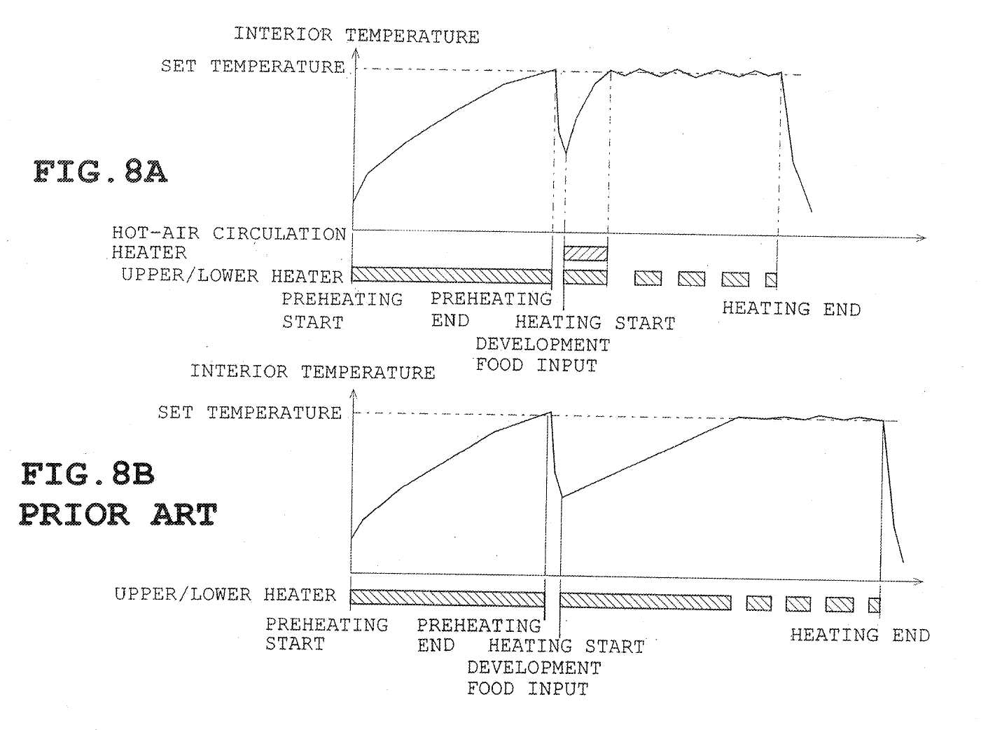

The operation of the microwave oven 1 will now be described with additional reference to FIG. 8A as well as to FIGS. 1 to 7B. FIG. 8A is a timing chart showing changes in an interior temperature in the case where a heating chamber is preheated and thereafter cooking is carried out by heaters. When preheating is to be initiated by the user, the control section 37 energizes the upper and lower heaters 17 and 18 so that the atmosphere in the heating chamber 4 is preheated. When the interior temperature reaches a set temperature (250° C., for example), the control section 37 controls the display 8 so that completion of the preheating step is displayed by the display 8. The user then opens the door 5 to put food or the like into the heating chamber 4 and re-closes the door 5 to start cooking. At this time, the interior temperature rapidly drops. In view of this problem, the hot-air circulation heater 23 powered from the secondary battery 34 is energized upon start of cooking simultaneously with the upper and lower heaters 17 and 18 in the embodiment, whereupon the interior temperature is quickly increased.

In this case, even when the microwave oven 1 has rated power consumption of, for example, 1500 W heating can be carried out with power higher than 1500 W since the secondary battery 34 is used together with the upper and lower heaters 17 and 18. The hot-air circulation heater 23 is de-energized when the interior temperature has reached the set temperature. Thereafter, the upper and lower heaters 17 and 18 are intermittently energized so that the interior temperature is maintained at the set temperature for execution of cooking.

FIG 8B is also a timing chart similar to FIG. 1 but shows temperature changes in a conventional microwave oven. In the conventional microwave oven, only the upper and lower heaters can be used for the limitation of rated power consumption even when the user opens the door after completion of the preheating such that the interior temperature has rapidly dropped. Furthermore, the heat capacity is increased since food or the like is accommodated in the heating chamber 4. Accordingly, a long time is necessitated until the interior temperature reaches the set temperature. As a result, a heating time for food or the like is prolonged, and the surface of food is dried, whereupon the finished state of food is degraded.

On the other hand, FIG. 8A shows a reduced time that is necessitated for the interior temperature to return from the value at start of heating after preheating to the set temperature regarding the embodiment.

In the above-described embodiment, the hot-air circulation heater 23 energized from the secondary battery 34 is operated in a part of heating period simultaneously with the upper and lower heaters 17 and 18. More specifically, when the atmosphere in the heating chamber 4 is preheated prior to start of cooking, the hot-air circulation heater 23 is operated for a predetermined period of time after completion of the preheating. The predetermined time period starts with initiation of heating and continues until the interior temperature reaches the set temperature. In other words, power supply from the secondary battery 34 is carried out for a predetermined period of time starting with initiation of heating or until the interior temperature reaches the set temperature.

Accordingly, even when the user opens the door 5 after completion of preheating such that the interior temperature rapidly drops and food or the like is accommodated in the heating chamber 4 such that the heat capacity is increased, the heating output can temporarily be increased so that the interior temperature is quickly returned to the set temperature in a short period of time. Consequently, the cooking time can be shortened and the surface of food can be prevented from being dried, whereupon the finished state of food can be improved. Furthermore, since the control section 37 of the microwave oven 1 causes the display 8 to display the charging state of the secondary battery 34, the user can determine whether heating using the secondary battery together with the heaters is executable, when viewing the aforesaid displayed contents.

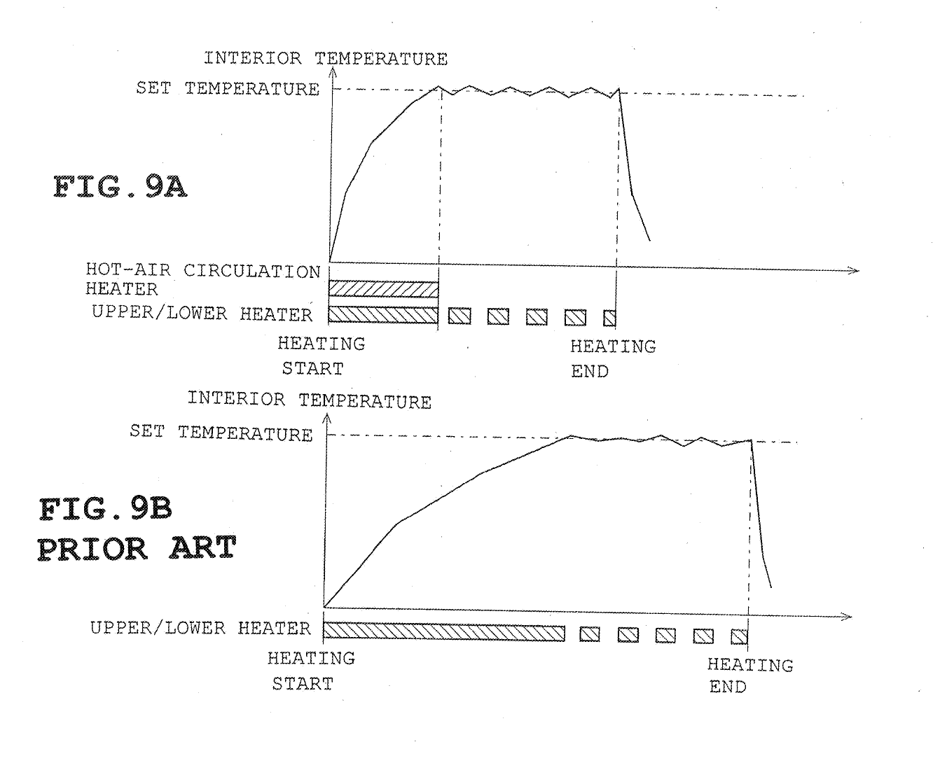

FIG. 9A illustrates a second embodiment of the invention. Identical or similar parts in the second embodiment are labeled by the same reference symbols as those in the first embodiment and the description of these parts will be eliminated. Only the differences of the second embodiment from the first embodiment will be described. The second embodiment differs from the first embodiment in a control manner in the heating operation. In the second embodiment, the heating operation is initiated without preheating for the heating chamber 4 although the preheating is carried out in the first embodiment.

In this case, the heating operation starts under the conditions where the interior temperature is substantially equal to the room temperature and food or the like is accommodated in the heating chamber 4 such that thermal capacity is large. Then, the control section 37 controls the hot-air circulation heater 23 and upper and lower heaters 17 and 18 so that these heaters 17, 18 and 23 are simultaneously energized thereby to be operated. When the interior temperature has reached the set temperature, the hot-air circulation heater 23 is de-energized and thereafter, the upper and lower heaters 17 and 18 are intermittently energized in the same manner as in the first embodiment so hat the interior temperature is maintained at the constant value.

In the case of a conventional arrangement as show in FIG. 9B, only the upper and lower heaters can be used for the limitation of rated power consumption and accordingly, rise of the interior temperature is retarded. Accordingly, a long time is necessitated until the interior temperature reaches the set temperature. As a result, a heating time for food or the like is prolonged, and the surface of food is dried, whereupon the finished state of food is degraded.

On the other hand, when cooking is initiated without preheating the atmosphere in the heating chamber 4 in the second embodiment, the hot-air circulation heater 23 energized from the secondary battery 34 is operated from the start of the heating operation simultaneously with the upper and lower heaters 17 and 18. Consequently, the cooking time can be shortened and the surface of food can be prevented from being dried, whereupon the finished state of food can be improved.

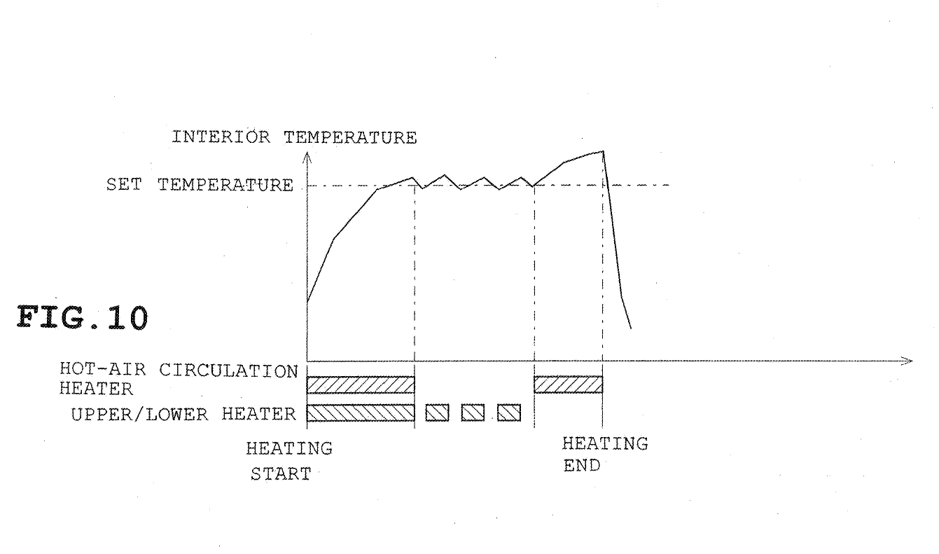

FIG. 10 illustrates a third embodiment of the invention. Only the differences of the third embodiment from the second embodiment will be described. In the third embodiment, the heating operation is initiated in the same manner as in the second embodiment. When the interior temperature has reached the set temperature, the upper and lower heaters 17 and 18 are intermittently energized so that the set temperature is maintained at the constant value. Immediately before completion of the cooking operation, the hot-air circulation heater 23 is energized again so that a heating operation is carried out at or above a predetermined temperature for a predetermined period of time. Thereafter, the cooking is completed.

For example, when gratin is cooked, it is preferred that a surface of the gratin is slightly browned. Accordingly, when control is carried out in the same manner as in claim 1, the heating output can temporarily be increased immediately before completion of cooking, whereby the surface of the food can be browned.

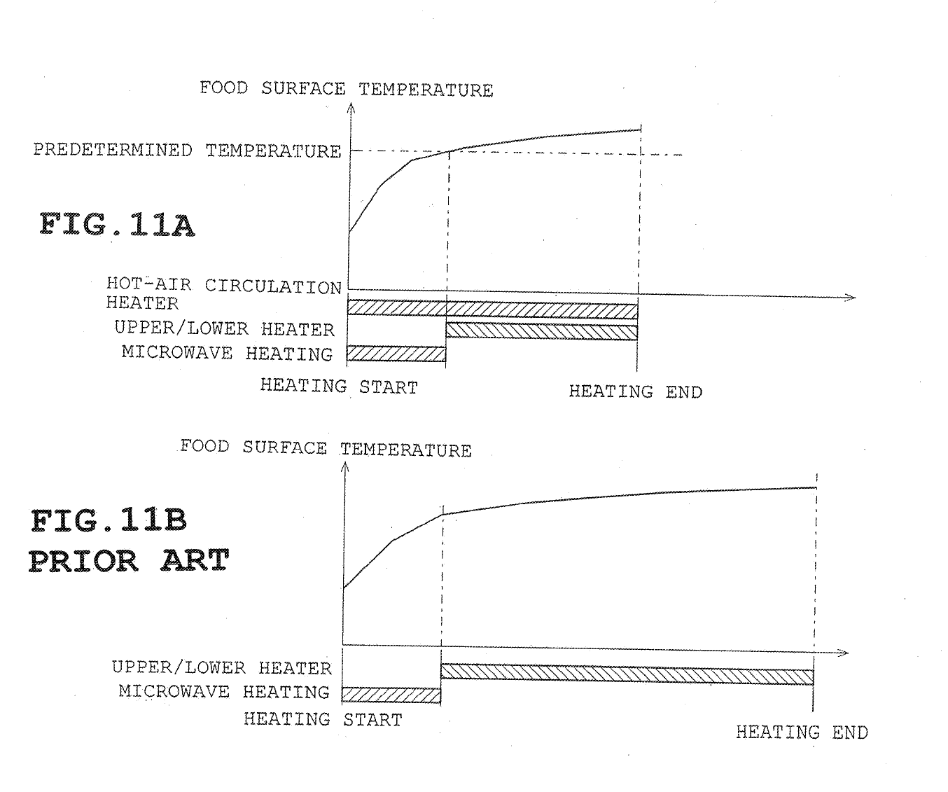

FIG. 11A illustrates a fourth embodiment of the invention. In the fourth embodiment, both heating by microwaves and heating by electric heaters are used as in frying, bread baking or the like. The microwaves re used to heat the inside of food, whereas the heaters are used to heat the surface of the food. On the other hand, FIG. 11B shows a conventional arrangement in which only the heating by microwaves is firstly carried out and thereafter, the heating by upper and lower heaters is carried out for the limitation of power consumption.

On the other hand, in the fourth embodiment, both of the magnetron 11 and the hot-air circulation heater 23 are operated, whereby both heating by microwaves and heating by electric heaters can be carried out simultaneously, as shown in FIG. 11A. The control section 37 then causes the infrared sensor 33 to detect the surface temperature of the food. When the detected temperature has reached a predetermined value, the magnetron 11 is de-energized and the upper and lower heaters 17 and 18 are operated, instead. Consequently, the cooking time can be shortened.

In the fourth embodiment, the control section 37 of the microwave oven 1 causes both magnetron 11 and hot-air circulation heater 23 to operate simultaneously immediately after start of the heating operation. When the surface temperature of the food to be cooked exceeds a predetermined temperature, the magnetron 11 is de-energized. Consequently, the microwave oven 1 of the embodiment can carry out frying or the like in a shorter period of time than the conventional microwave oven. Furthermore, the timing of stop of microwave heating can suitably be set.

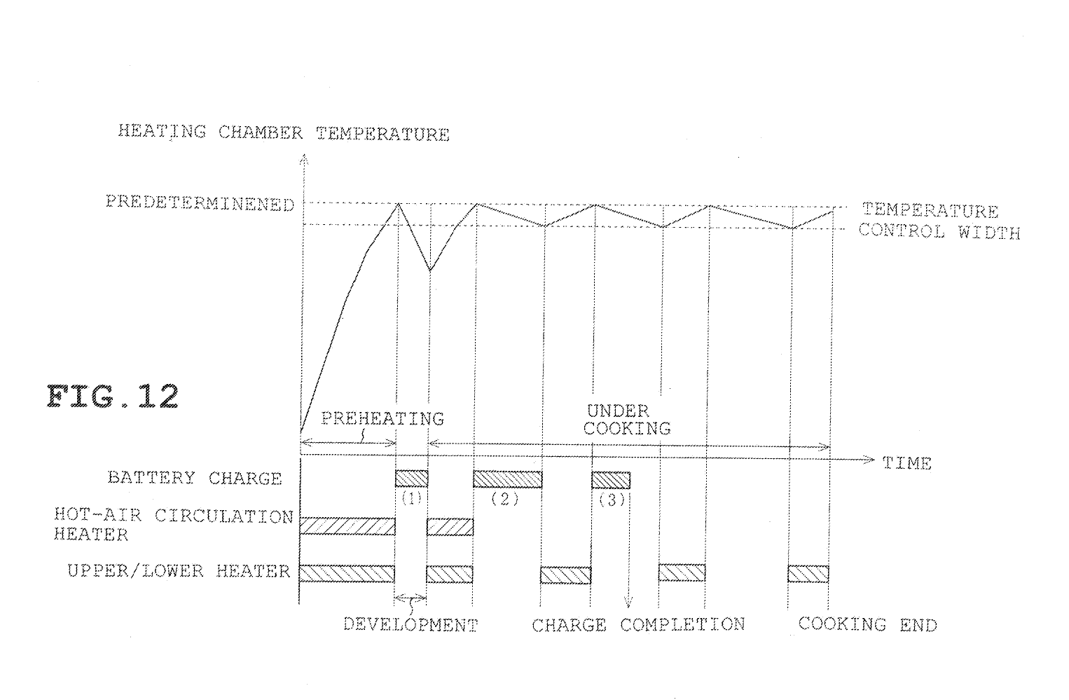

FIG 12 illustrates a fifth embodiment of the invention. Only the differences of the fifth embodiment from the first embodiment will be described. In the fifth embodiment, the hot-air circulation heater 23 is operated together with the upper and lower heaters 17 and 18 in the heating pattern as described in the first embodiment also when the preheating is carried out. Thus, the time necessitated for the preheating can also be shortened. FIG. 12 further shows a charging period for the secondary battery 34.

Charging is carried out for a time period (1) between completion of the preheating and start of the heating by the hot-air circulation heater 23. Upon completion of the preheating, the door 5 of the microwave oven 1 is opened so that food is put into the heating chamber 4. The door 5 is then closed and thereafter, the heating is carried out by the hot-air circulation heater 23. Charging is also carried out for time periods (2) and (3) in which the upper and lower heaters 17 and 18 are de-energized during the cooking respectively. FIG. 12 shows the case where the secondary battery 34 becomes full-charged during the charging period (3) and charging is then stopped. More specifically, since the secondary battery 34 is quickly rechargeable, it can be recharged to some degree even in an extremely short period of time.

In the fifth embodiment, power supply from the secondary battery 34 is carried out during the preheating for the heating chamber 4 and also in the period starting from initiation of heating after the preheating and ending with the time when the interior temperature reaches the set temperature. Consequently, the cooking time period can further be shortened in total. Furthermore, the secondary battery 34 is recharged in the period starting from completion of the preheating to re-closure of the door 5 after the door has been opened and food to be cooked is put into the heating chamber 4. The secondary battery 34 is also recharged in the period during which the upper and lower heaters 17 and 18 are turned off in the cooking period. Thus, since the charging is carried out while neither heater is energized, the power consumption of the microwave oven 1 can be prevented from being excessively large.

The invention should not be limited by the embodiments described above with reference to the drawings. The embodiments may be modified or expanded as follows. The specified electrothermal heating unit may be the upper or lower heater 17 or 18. For example, when the specified electrothermal heating unit is the upper heater 18 in the third embodiment, food surface can easily be browned when gratin is made.

The charge of the secondary battery 34 may be based on the user's operation. More specifically, the power consumption of the microwave oven 1 is temporarily increased when the secondary battery 34 is charged. Accordingly, when the charging is automatically carried out, a breaker installed on a household distribution board can operate depending upon the condition where other household appliances are in use, whereupon the commercial power supply may be expected to be interrupted. Accordingly, the breaker can be prevented from operating when the user operates the operating section 7 in the case where the user confirms the status of use of the household appliances and determines that the secondary battery 34 may be recharged.

The control section 37 may refer to an output state of the charge amount detecting circuit 39 to estimate a time period necessary for the secondary battery 34 to be recharged. The estimated charging time period may be displayed on the display 8. More specifically, since the charging characteristic of the secondary battery 34 is constant as shown in FIG. 5, the recharging time necessary for the secondary battery 34 can be estimated based on the charging characteristic thereof. Accordingly, the user can refer to the estimated charging time, thereby determining whether or not cooking should be started with the secondary battery 34 being used together with the upper and lower heaters.

Furthermore, the control section 37 may estimate a time period in which electric power can be supplied from the secondary battery 34 to the hot-air circulation heater 23. More specifically, a power suppliable time period of the secondary battery 34 can be estimated from a dropped state of the terminal voltage, the difference between an initial discharge capacity and an actually discharged capacity. Accordingly, the user can refer to the estimated time period to determine whether or not cooking should be started with the secondary battery 34 being used together with the upper and lower heaters or whether or not the actually executed cooking should be continued.

The door 5 is sometimes opened and closed for the purpose of adding condiment, reversing food or the like during the cooking. In this case, too, the interior temperature drops. Accordingly, when the door 5 is re-closed and the cooking is re-started, heating by the hot-air circulation heater 23 may be carried out for a predetermined period of time starting with re-start of cooking or until the interior temperature reaches the set temperature.

The number of electrothermal heating units may be one, two, four or above.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A microwave oven comprising:
a heating chamber into which an object to be heated is placed and heated for a predetermined period of time;
a microwave heating unit;
a plurality of electrothermal heating units; and
a secondary battery charged by a commercial AC power supply and supplying electric power to at least a specific one of the electrothermal heating units, wherein the predetermined heating period of time includes a part in which the specific electrothermal heating unit to which electric power is supplied by the secondary battery is operated simultaneously with the other heating units.

2. The microwave oven according to claim 1, wherein the heating chamber has a ceiling and an underside and the electrothermal heating units include radiant heaters disposed on the ceiling and the underside of the heating chamber respectively and a hot-air circulation heater provided for circulating hot air into the heating chamber.

3. The microwave oven according to claim 1, wherein when cooking starts after the heating chamber has previously been heated, the specific electrothermal heating unit is operated for a predetermined period of time starting from the time of heating start after completion of the preheating.

4. The microwave oven according to claim 1, wherein when cooking starts without execution of the preheating, the specific electrothermal heating unit is operated for a predetermined period of time starting from the time of heating start.

5. The microwave oven according to claim 3, further comprising a temperature detecting unit detecting a temperature in the heating chamber, wherein heating by the specific electrothermal heating unit is stopped after the temperature in the heating chamber exceeds a predetermined temperature.

6. The microwave oven according to claim 4, further comprising a temperature detecting unit detecting a temperature in the heating chamber, wherein heating by the specific electrothermal heating unit is stopped after the temperature in the heating chamber exceeds a predetermined temperature.

7. The microwave oven according to claim 1, wherein the specific electrothermal heating unit is operated for a predetermined period of time in a latter half of heating.

8. The microwave oven according to claim 1, wherein at least the specific electrothermal heating unit and the microwave heating unit are simultaneously operated.

9. The microwave oven according to claim 8, further comprising a temperature detecting unit detecting a temperature of the object to be heated, wherein heating by the microwave heating unit is stopped when the temperature of the object to be heated exceeds a predetermined temperature.

10. The microwave oven according to claim 1, further comprising a display unit displaying a charging status of the secondary battery.

11. The microwave oven according to claim 1, wherein the secondary battery is charged while the electrothermal heating unit is turned off during the heating period of time.

12. The microwave oven according to claim 1, wherein the cooking chamber has an opening through which the object to be heated is put into and taken out of the heating chamber, which further comprises a door pivotally mounted on the oven so as to close and open the opening of the heating chamber, wherein the secondary battery is charge until the door is closed after the door has been opened and the object to be heated has been put into the heating chamber.

13. The microwave oven according to claim 1, wherein electric power is supplied from the secondary battery to the specific electrothermal heating unit during preheating of the heating chamber and until the temperature in the heating chamber reaches a set temperature from start of heating after the preheating.
